(19) United States
(12) Patent Application Publication
(10) Pub. No.: US 2007/0141379 A1
(43) Pub. Date: Jun. 21, 2007

(54) Powder-coated spinning wire and fabrication method thereof

(75) Inventor: Joung-Eun Kim, Busan (KR)

Correspondence Address: LAW OFFICE OF DELIO & PETERSON, LLC., 121 WHITNEY AVENUE, 3RD FLLOR, NEW HAVEN, CT, 06510, US

(73) Assignee: Kiswire, Ltd., Busan (KR)

(21) Appl. No.: 11/582,274

(22) Filed: Oct. 16, 2006

(30) Foreign Application Priority Data
Dec. 15, 2005 (KR) S/N 124021/2005

(51) Int. Cl. B21C 37/00; B32B 15/08; C25D 5/10; B05D 3/00; B05D 7/00; B05D 3/02; B05D 5/12

(52) U.S. Cl. 428/607; 428/626; 428/659; 427/421.1; 427/299; 427/374.1; 427/117

(57) ABSTRACT

The invention relates to a powder-coated spinning wire used for a main cable of a suspension bridge and a fabrication method thereof. The powder-coated spinning wire has a shot-blasted plating layer and a powdered coat formed in their order on a core wire. The plated core wire is shot-blasted to roughen the plating layer and remove an oxide layer. Then, the core wire is first heated, sprayed with powder paint, and second heated. The plating layer is formed at an amount of 50 g/m² to 300 g/m², and the powdered coat has a thickness ranging from 10 μm to 400 μm. The powder-coated spinning wire has corrosion resistance and endurance improved. Since heated powder coating is adopted instead of electrostatic powder coating, powder coating equipment can be simplified and the productivity of the powder coating can be improved also.

### BACKGROUND OF THE INVENTION

1. Field of the Invention

The present invention relates to a powder-coated spinning wire and a fabrication method thereof, and more particularly, to a powder-coated spinning wire used as a main cable of a suspension bridge and a fabrication method thereof, in which shot blasting and subsequent powder coating are carried out onto the surface a core wire plated with Zn or Zn containing Al in order to prevent any influence from harsh corrosive environments regardless of exposure to such environments for an extended period of time.

2. Description of the Prior Art

As generally known in the art, a spinning wire (or air spinning wire) is a steel wire used as a main cable of a suspension bridge. Since the spinning wire is used in very harsh environments, anticorrosive properties thereof are very important because of the following reasons:

A suspension bridge has a very long distance between cable towers, which is spanned by merely a pair of main cables without any supports in-between. A number of hanger ropes are suspended from the main cables at a predetermined interval, with top ends connected to the main cable and bottom ends connected to the deck or roadbed. Unlike other bridges where the roadbed is installed on piers, the suspension bridge supports the deck with the hanger ropes connected to the main cables.

Owing to the characteristics of the suspension bridge, the main cables and hanger ropes suffer from severe strains such as fatigue load, together with heavy stresses such as torsion owing to traffic, irregular directions and velocity of the wind, seasonal temperature variation and so on. Accordingly, the main cables are subjected to longitudinal deformation.

In particular, since a great magnitude of load is concentrated on the main cables which are connected with a number of the hanger ropes to suspend the hanger ropes and the deck, any localized rust may propagate rapidly through the main cables, resulting in severe loss of manpower and material. Therefore, rust prevention of the main cables is essential.

Such a main cable is made of hundreds to thousands of yarns of steel wire, so called spinning wire, which are by bound around their outer circumference with rings at a predetermined interval. The spinning wire is made of a steel wire and Zn or Zn containing Al is plated on the steel wire. The main cable itself is wrapped in a polyvinyl chloride (PVC) pipe, such that it can be protected from external corrosive environment as well as possible.

However, since various cables and steel wires in use for a suspension bridge are exposed to rain and/or snow during the construction period of the bridge up to several years, Zn in a plating layer on the surface of a steel wire is subject to chemical reaction as in Formula 1.

2H₂O+Zn=Zn(OH)₂+H₂. . . . Formula (1)

Hydrogen gas generated through the above Zn corrosion reaction may penetrate into the steel wire, potentially causing hydrogen embrittlement. To prevent it, hot air blowers are installed at a construction site to dry cables and steel wires during the construction period of the suspension bridge. However, it is impossible to provide a perfect shield against moisture for a long time.

Accordingly, another approach is also adopted in addition to the hot air blowers, in which anticorrosive paste is applied onto the surface the Zn-plated wire, wrapping wire is wound on the anticorrosive past layer, and a coat is applied on the wrapping wire. However, under a hot and humid corrosion environment, the aging of the paste is hastened, which tends to hasten the aging of the outer layer of the wire.

Chromating is used as a primary anticorrosive processing for the Zn-plating layer. However, rain water and the like may dissolve Cr out of the chromated layer, causing environmental pollution. Thus, such an approach has not been applied since the 1980s.

As an approach to replace the chromating, Japanese Patent Application Publication 05-179587 discloses a colored coating composition for a Zn-plated wire and a method for fabricating a colored Zn-plated wire for a cable having a coat. The coating composition comprises, as essential components, (a) a phenoxy resin having a mean molecular weight of 8,000 to 20,000 or a fatty-acid modified or unmodified epoxy resin having an epoxy equivalent of 300 or more, (b) at least one curing agent selected from uric resins, melamine resins and poly isocyanate compounds and (c) a coloring pigment, where (a+b)/c has a weight ratio of 95/5 to 50/50. The colored Zn-plated wire is fabricated by applying the coating composition onto the wire surface, and thermally curing the composition to form a coat. However, this approach has a drawback of imperfect adherence between the wire and the coat.

Another approach is disclosed in Japanese Patent Application Publication No. 06-272181, in which a Zn-plated steel core wire is placed into a pressure vessel, the air is evacuated from the pressure vessel, a liquid synthetic resin is injected into the pressure vessel, the pressure vessel is then pressurized and maintained at the ambient pressure, and then the coated core wire is removed out of the pressure vessel to cure the synthetic resin. However, this approach fails to prevent corrosion at voids inside a coat. Furthermore, Zn corrosion owing to moisture penetration or residence may cause hydrogen embrittlement.

### SUMMARY OF THE INVENTION

Accordingly, the present invention has been made to solve the above-mentioned problems occurring in the prior art spinning wire used for a main cable for a large sized structure such as a suspension bridge. Therefore, an object of the present invention is to provide a powder-coated spinning wire having a synthetic resin coat, which can prevent the Zn plating layer from corroding and maintain corrosion resistance against external environments owing to excellent adherence with the Zn plating layer while maintaining the characteristics of the plated wire, and a fabrication method thereof.

To realize the above object, the invention adopts shot blasting and powder coating.

The powder-coated spinning wire of the invention has a synthetic resin powder coated onto the surface of a spinning wire plated with Zn or Zn containing Al. Before the powder coating, the amount of Zn or Zn containing Al and the thickness of the powder coating is adjusted to a specific range, the plated wire is degreased, washed and dried. Then, the shot blasting is carried out by shots or grits classified according to equal or similar screen mesh number (hereinafter will be referred to “shot”) under certain conditions.

### BRIEF DESCRIPTION OF THE DRAWINGS

The above and other objects, features and advantages of the present invention will be more apparent from the following detailed description taken in conjunction with the accompanying drawing, in which:

FIG. 1 is a cross-sectional view illustrating a powder-coated spinning wire according to an embodiment of the invention.

### DETAILED DESCRIPTION OF THE PREFERRED EMBODIMENTS

Hereinafter, a preferred embodiment of the present invention will be described with reference to the accompanying drawings. In the following description and drawing, the same reference numerals are used to designate the same or similar components, and so repetition of the description on the same or similar components will be omitted.

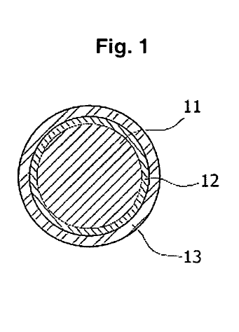

As shown in FIG. 1, the powder-coated spinning wire has a cross-sectional structure in which a plating layer 12 and a powder-coated layer 13 are formed in that order on the surface of a steel core wire 11. The plating layer 12 is made of Zn or Zn containing Al plated on the surface of the wire 11. The plating layer 12 is applied at an amount in the range of 50 g/m² to 300 g/m², and the powder-coated layer is applied at a thickness ranging from 10 μm to 400μm.

That is, when the amount of the plating layer is under 50 g/m², the plating layer becomes too thin. This may locally expose the surface of the core wire and hardly obtain normal sacrificing corrosion by Zn. At an amount exceeding 300 g/m², delamination owing to excessive plating may take place.

On the other hand, when the thickness of the powder-coated layer is less than 10 μm, the powder-coated layer may peel off owing to contact with external objects. At a thickness exceeding 400 μm, the adherence to the plating layer degrades to the contrary, thereby causing cracks on the outer circumference. Therefore, it is desirable to limit the amount of the plating and the thickness of the coated layer to within the above-stated ranges.

As described above, the powder-coated spinning wire of the invention has the plating layer 12 and the powder-coated layer 13 applied in that order onto the core wire 11. The powder-coated spinning wire is fabricated according to a series of procedures in the following sequence: heat treatment to a steel rod; pretreatment and elongation; surface treatment; Zn or Zn containing Al plating; degreasing, washing and drying; shot blasting; powder coating. In particular, the invention is characterized in the shot blasting and the powder coating.

Here, an additional elongation may be carried out between the plating and the degreasing.

To perform the shot blasting as an essential procedure of the invention, a core wire with an initial plating amount of 100 g/m² to 400 g/m² is degreased, washed clean and then dried. Then, the shot blasting is performed at a shot diameter of 0.2 mm to 0.8 mm. Due to the shot blasting, the amount of the plating drops from the previous level of 100 g/m² to 400 g/m² to a lower level of 50 g/m² to 300 g/m².

That is, the shot blasting roughens the surface of the plated core wire while removing a zinc oxide layer from the surface of the plating layer in order to enhance adherence between the plating layer and the powder-coated layer to be formed thereon later. At the same time, the shot blasting also removes voids in the plating layer while raising the density of the plating layer, thereby enhancing the stability of the plating layer. Furthermore, the shot blasting also adjusts the amount of the plating to a level most advantageous for anticorrosive properties. Accordingly, the injection amount of the shot blasting should be adjusted to such a range that can roughen the surface of the plated core wire while dropping the amount of the plating from 100 g/m² to 400 g/m² to 50 g/m² to 300 g/m².

The shot diameter in the shot blasting is also preferably limited to an optimum range. At a shot diameter less than 0.2 mm, impact onto the plated core wire is insufficient, which then does not effectively form concaves in the plating layer. This as a result may cause insufficient adherence between the plating layer and the powder-coated layer so that the powder-coated layer may delaminate from the plating layer. At a shot diameter exceeding 0.8 mm, impact onto the plating layer is too excessive so that the plating layer may delaminate from the core wire or friction-induced abrasion may drop the amount of the plating sharply.

After the shot blasting carried out as above, the powder coating is performed. The powder coating is performed according to heated powder coating rather than electrostatic powder coating where a supply voltage is applied to the plated core wire. In the powder coating, synthetic resin powder of powder paint is sprayed and coated onto the primarily heated wire while it is moving, and then the wire coated with powder paint is heated a second time, followed by cooling down. The heating temperature and moving speed of the core wire are adjusted to control the thickness of the powder-coated layer.

Here, when heating the wire before and after the spraying of the powder paint, temperature is maintained in the range of 150° C. to 350° C. according to the type of the powder paint and the moving speed of the core wire.

In the meantime, the method of the invention does not apply electrostatic powder coating for the following reasons. First, the electrostatic powder coating cannot increase the thickness of the powder-coated layer sufficiently to the upper limit of the invention. Second, the Zn plating layer on the wire has poor electric conductivity, and thus makes it difficult to perform electrostatic powder coating.

The synthetic resin for forming the powder-coated layer may be composed of various types of material. For example, any of acrylic and fluoro resins of excellent weather resistance and epoxy resins of excellent corrosion resistance can be selectively used.

As described hereinbefore, the powder-coated spinning wire of the invention has adherence between the plating layer and the powder-coated layer maximized owing to the shot blasting, and thus its corrosion resistance and endurance are improved significantly over those of conventional wires. Since heated powder coating is applied instead of electrostatic powder coating, powder coating equipment can be simplified and the productivity of the powder coating can be improved also.

Furthermore, since individual spinning wires are powder-coated, a main cable made by binding the spinning wires in a bundle can have remarkably improved corrosion resistance and endurance. This as a result can prolong the lifetime of a bridge where such cables are installed.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A powder-coated spinning wire in use for a suspension bridge comprising:
a core wire;
a plating layer applied on an outer circumference of the core wire, the plating layer comprising a Zn-plating layer or a Zn-plating layer containing Al which is shot-blasted; and
a powder coat applied on an outer circumference of the plating layer.

2. The powder-coated spinning wire according to claim 1, wherein the plating layer is applied at an amount ranging from 50 g/m² to 300 g/m² and the powder coat has a thickness ranging from 10 μm to 400 μm.

3. A method for fabricating a powder-coated spinning wire as described in claim 1, the method comprising steps of:
degreasing, washing and drying a plated core wire having a plating amount in the range from 100 g/m² to 400 g/m²;
shot-blasting the plated core wire to roughen a plating layer and dropping the plating amount to 50 g/m² to 300 g/m²;
primarily heating the plated core wire while it is moving, spraying powder paint onto an outer circumference of the core wire, and secondly heating the core wire; and
cooling the core wire coated with the powder paint to cure a powder-coated layer.

4. The method according to claim 3, wherein the shot blasting is carried out at a shot diameter in the range from 0.2 mm to 0.8 mm or a grit diameter in the equal range.

5. The method according to claim 3, wherein the powder-coated layer has a thickness in the range from 10 μm to 400 μm.

6. The method according to claim 3, wherein the first and second heating is carried out at a temperature in the range from 150° C. to 300° C.
